(19) United States
(12) Patent Application Publication
(10) Pub. No.: US 2006/0030370 A1
(43) Pub. Date: Feb. 9, 2006

(54) Custom idle screen for a mobile device

(75) Inventor: Yavor Eliad Wardimon, Binyamina (IL)

Correspondence Address: FARSHAD JASON FARHADIAN;CENTURY IP LAW GROUP, P.O. BOX 7333, NEWPORT BEACH, CA, 92658-7333, US

(73) Assignee: Mobile (R&D) Ltd.

(21) Appl. No.: 10/913,585

(22) Filed: Aug. 5, 2004

(51) Int. Cl. H04B 1/38; H04M 1/00; H04M 3/00

(52) U.S. Cl. 455/566; 455/418; 455/419

(57) ABSTRACT

A method of customizing an idle screen for a mobile device is provided. The method comprises selecting a first screen displayed on the mobile device by interacting with a user interface of the mobile device; and displaying the first screen on a display of the mobile device when the mobile device is in a first mode.

### BACKGROUND

### Field of Invention

The present invention relates generally to customizing a display setting and, more particularly, to a system and method for customizing the idle screen for a mobile device.

### Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### Related Art

Mobile devices, particularly cellular phones, are so popular that manufacturers and service providers continuously add additional features and functionality to their products to attract more buyers and subscribers. Each additional function is typically accessible via the mobile device's graphic user interface or menu.

As the number of features increases, the burden is on the user to learn how to interface with the device's menu to use a particular feature. Sometimes the user has to browse through multiple levels of menus in order to access a certain feature or manipulate the phone to perform an operation.

If the user is particularly fond of certain features or uses the device to perform a function on a regular basis, browsing the multiple menu levels to access such features can be very inconvenient. For example, a user may want to check the inbox for the received text messages 3 or 4 times every hour. In order to do this, the user may have to go through several intermediary screens and press several buttons to view the inbox screen.

Understandably, it would be very helpful for the user to bypass the intermediary screens and get to the often-used screen in a more expedited manner. Methods and systems are needed that can accommodate the user accordingly.

### SUMMARY

The present disclosure is directed to a system and corresponding methods that facilitate the process of customizing an idle screen for a mobile device.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method of customizing an idle screen for a mobile device is provided. The method comprises selecting a first screen displayed on the mobile device by interacting with a user interface of the mobile device; and displaying the first screen on a display of the mobile device when the mobile device is in a first mode. The mobile device is a communication device in one embodiment and the first mode is an idle mode.

The above method, in one or more embodiments, further comprises selecting a second screen displayed on the mobile device by interacting with the user interface of the mobile device; setting one or more conditions under which the first and second screens are to be displayed; and displaying the first and second screens on the display of the mobile device when the device is in the first mode, in accordance with the one or more conditions. The first mode is an idle mode.

In accordance with another aspect of the invention, a mobile communication device comprises means for selecting a first screen displayed on the mobile device by interacting with a user interface of the mobile device; and means for displaying the first screen on a display of the mobile device when the mobile device is in a first mode or an idle mode.

The mobile communication device, in one embodiment, further comprises means for selecting a second screen displayed on the mobile device by interacting with the user interface of the mobile device; means for setting one or more conditions under which the first and second screens are to be displayed; and means for displaying the first and second screens on the display of the mobile device when the device is in the first mode, in accordance with the one or more conditions.

In accordance with yet another embodiment, a computer readable medium for storing logic code executable by a microcontroller is provided. In this embodiment, the logic code comprises the steps of selecting a second screen displayed on the mobile device by interacting with the user interface of the mobile device, wherein a first screen defines the idle screen; setting one or more conditions under which the first and second screens are to be displayed; and displaying the first and second screens on the display of the mobile device when the device is a first and a second mode, respectively, in accordance with the one or more conditions.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary system environment, in accordance with one or more embodiments of the invention;

FIG. 2 is a flow diagram of a method of customizing an idle screen for a mobile device, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide a method and system for customizing an idle screen for a mobile device.

Electronic services, services, and online services are used interchangeably herein. The services provided by the system of this invention, in one or more embodiments, are provided by a service provider. A service provider is an entity that operates and maintains the computing systems and environment, such as server systems and infrastructures that enable the delivery of information. Typically, server architecture includes components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

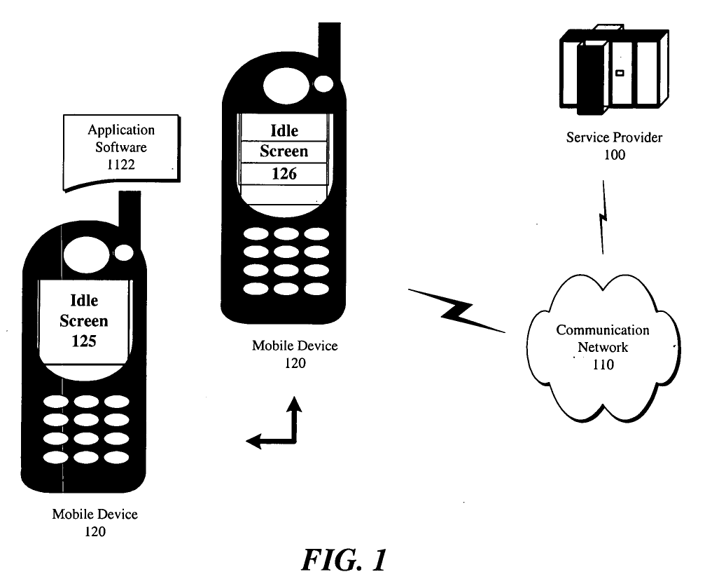

Referring to the drawings, FIG. 1 illustrates an exemplary system environment in which the present invention may operate. In accordance with one aspect of the invention, the system environment comprises a service provider 100, a communication network 110, and a mobile device 120. The service provider 100 and mobile device 120 are connected by way of the communication network 110. The terms “connected,” “coupled,” or any variant thereof, mean any connection or coupling, either direct or indirect, between two or more elements. The coupling or connection between the elements can be physical, logical, or a combination thereof.

In one embodiment, the communication network 110 provides the medium and infrastructure for transmitting digital or analog signals between service provider 100 and mobile device 120. In certain embodiments, mobile device 120 is a cellular telephone and communication network 110 is a wireless telephone network, for example. Mobile device 120, service provider 100 and communication network 110, however, may be implemented over any type of mobile, fixed, wired or wireless communication technology (e.g., landline telephony, cellular, radio, radar, infrared, etc.).

One of ordinary skill in the art will appreciate that communication network 110 may advantageously be comprised of one or a combination of various types of networks without detracting from the scope of the invention. Such networks can, for example, comprise personal area networks (PANs), local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications networks that can provide a means of communication between mobile device 120 and service provider 100.

In some embodiments, communication network 110 can be a part of the world wide web (i.e., the Internet). The Internet, in a well-known manner, connects millions of computers world wide through standard common addressing systems and communications protocols (e.g., Transmission Control Protocol/Internet Protocol (TCP/IP), HyperText Transport Protocol) creating a vast communications network.

In either context, mobile device 120 can communicate with service provider 100 to send and receive electronic packets of information, in form of electronic requests and responses. In a particular embodiment, the packets are constructed based on a messaging service, such as short messaging service (SMS), instant messenger (IM) service, or multimedia messaging service (MMS). SMS, IM and MMS enable messages comprising text or multimedia content to be communicated to mobile device 120.

In accordance with one aspect of the invention, application software 1122 is installed or executed on one of mobile device 120, service provider 100, a third party portal, or a combination of said systems to allow a user to customize mobile device 120's idle screen. An idle screen typically comprises the graphic or text that appears on mobile device 120's display when mobile device 120 is in an idle state. In one embodiment, the idle screen displays the time, for example, or the root menu level from which a user can access other display directories or subdirectories by pressing one or more buttons.

In one embodiment, a user may press a first button to access a first directory menu that provides the user with options to access information stored in mobile device 120 related to, for example, user's event calendar, phone book, SMS messages, voice messages, call history, games, etc. If the user wants to view the SMS messages, for example, the user then presses an arrow button to select an option that provides access to the SMS message screen. The user after selecting the option, then presses a button to confirm his selection. He is then provided with a screen that contains a list of SMS messages, for example.

In one embodiment, application software 1122 is implemented to allow a user to select a particular screen to be displayed instead of the default idle screen. This gives the user the option of switching the idle screen to a screen that the user views most frequently, for example. As such, the user will be able to immediately view the respective screen, without having to press multiple buttons and going through selecting from a hierarchy of menus and submenus as discussed above.

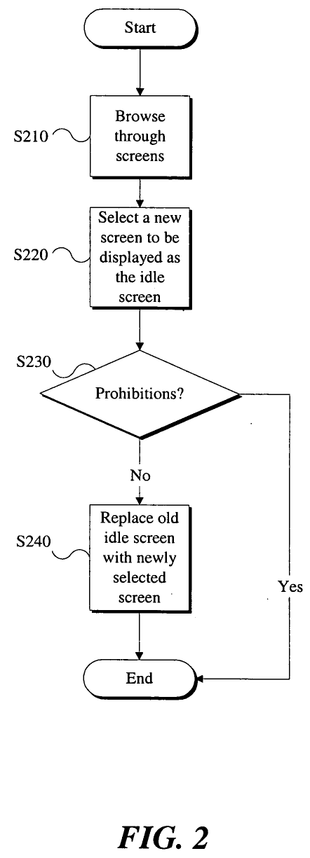

As shown in FIG. 1, idle screen 125 is an exemplary representation of mobile device 120's default idle screen. Referring to FIG. 2, in accordance with one embodiment, a user interacts with mobile device 120's user interface to browse through mobile device 120's menu screens (S210). Application software 1122 provides the user with the option to set any screen displayed on mobile device 120 as the idle screen.

For example, a user who often accesses his or her inbox for incoming SMS messages may want to set the inbox screen as the new idle screen (e.g., idle screen 126). Another user may want to set the calendar or phone book screen to be displayed while mobile device 120 is idling. To accomplish this, the user interacts with mobile device 120's user interface to select a new screen to be displayed as the idle screen (S220).

This may be done in an exemplary embodiment by way of selecting from an “options” menu, or by pressing a special button on mobile phone 120's keypad. In other embodiments, different methods for setting a new idle screen may be implemented. As such, the above-provided methods are not to be construed as limiting the scope of the invention to the exemplary embodiments discussed herein.

In some embodiments, once the user has selected a new screen to replace the previous idle screen, application software 1122 verifies whether the are any prohibitions against setting the selected screen as the idle screen (S230). For example, mobile device 120's display system may not be equipped with an option to set the selected screen as the idle screen. Or, it may be inappropriate to set the selected screen as the idle screen. For example, if the selected screen results in a substantial drain on the battery, application software 1122 may prohibit the user from selecting it as the idle screen.

If there are no prohibitions, application software 1122 replaces the old idle screen with the newly selected screen by the user (S240). As a result, the next time mobile phone 120 enters the idle mode the newly selected screen is displayed. Application software 1122, in one embodiment, allows the user to switch the idle screen to display any screen displayable on mobile device 120. For example, in one embodiment of the invention, where mobile device 120 can connect to a network server or the Internet, application software 1122 allows the user to select a network environment or web page to be displayed on mobile device 120's display when it is in an idle state.

In certain embodiments, application software 1122 is implemented to allow a user to select more than one idle screen. When more than one idle screen is selected, application software 1122 provides the user with the option of providing a set of conditions under which each idle screen should be displayed. For example, a user may wish to have a first idle screen being displayed before 12.00 pm and a second idle screen after 12.00 pm.

As used herein, the terms mobile device, third party portal, service provider and communication network are to be viewed as designations of one or more computing environments that comprise application, client or server software for servicing requests submitted by respective software included in devices or other computing systems connected there to. These terms are not to be otherwise limiting in any manner. Application software 1122, for example, may be comprised of one or more modules that execute on one or more computing systems, provided above.

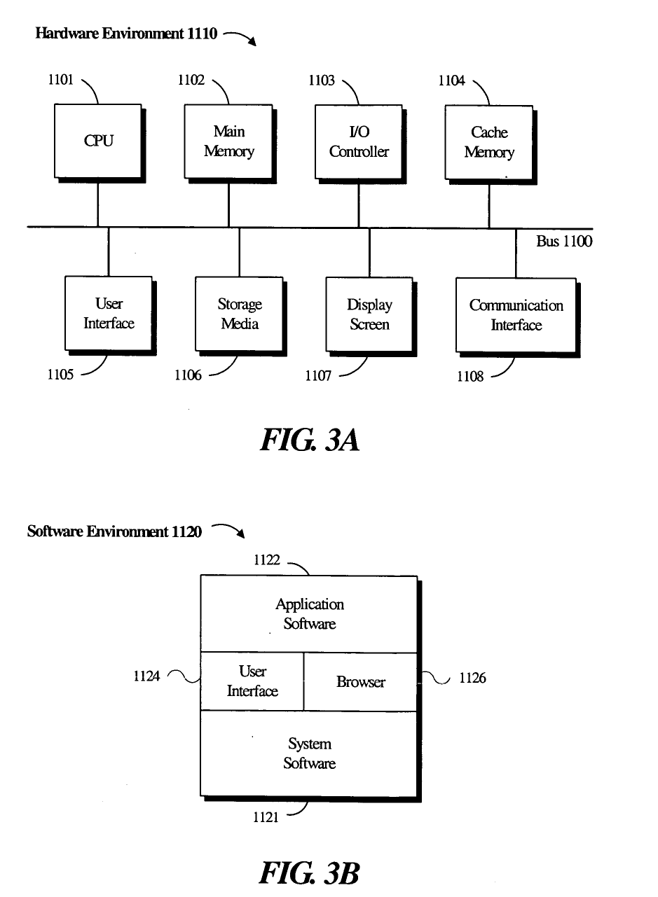

In one or more embodiments of the system, service provider 100, communication network 110, and mobile device 120 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task. In embodiments of the invention, system and application software are implemented and executed on one or more hardware environments to allow a user customize the mobile device's idle screen.

Referring to FIG. 3A, an embodiment of application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a modem, or a wireless communication chipset) and a system synchronizer (e.g., a clock).

Processor 1101 may or may not include cache memory 1104 utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in one embodiment of the system, mobile device 120 may be a PMG phone or equivalent.

In certain embodiments of the system, communication interface 1108 can send and receive electrical, electromagnetic, or optical signals that carry digital data streams representing various types of information including program code. If communication is established via the Internet, hardware environment 1110 may transmit program code through an Internet connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 1101 is a microprocessor manufactured by Motorola, Qualcomm, Texas Instruments, Intel, or Sun Microsystems Corporations. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software such as an operating system that controls the low-level operations of hardware environment 1110. Low-level operations comprise the management of the system's resources such as memory allocation, file swapping, and other core computing tasks. In one or more embodiments of the invention, the operating system comprises at least one of Symbian, Nucleus, Microsoft Windows, Palm, or Macintosh operating systems. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and server software. Referring to FIG. 1, for example, in one embodiment of the invention, client software is executed on mobile device 120 and server software is executed on service provider 100.

Software environment 1120 may also comprise web browser software 1126 for communicating with the Internet. Further, software environment 1120 may comprise a user interface 1124 (e.g., a Graphical User Interface (GUI)) for receiving user commands and data. The commands and data received are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate recognizing and displaying messages received by a mobile device 120 in accordance with predefined categories. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein. Further, the order in which the steps of the present method are performed is purely illustrative in nature. In fact, the steps can be performed in any order or in parallel, unless indicated otherwise in the present disclosure.

The method of the present invention may be performed in either hardware, software, or any combination thereof. In particular, the present method may be carried out by software, firmware, or macrocode operating on a computer or computers of any type. Additionally, software embodying the present invention may comprise computer instructions and be stored in a recording medium (e.g., memory stick, ROM, RAM, magnetic media, punched tape or card, compact disk (CD), DVD, etc.). Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention.

The embodiments described above are to be considered in all aspects as illustrative only and not restrictive in any manner. Thus, other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of customizing an idle screen for a mobile device, the method comprising:
selecting a first screen displayed on the mobile device by interacting with a user interface of the mobile device; and
displaying the first screen on a display of the mobile device when the mobile device is in a first mode.

2. The method of claim 1, wherein the mobile device is a communication device.

3. The method of claim 1, wherein the first mode is an idle mode.

4. The method of claim 1, further comprising:
selecting a second screen displayed on the mobile device by interacting with the user interface of the mobile device;
setting one or more conditions under which the first and second screens are to be displayed; and
displaying the first and second screens on the display of the mobile device when the device is in the first mode, in accordance with the one or more conditions.

5. The method of claim 4, wherein the first mode is an idle mode.

6. A mobile communication device comprising:
means for selecting a first screen displayed on the mobile device by interacting with a user interface of the mobile device; and
means for displaying the first screen on a display of the mobile device when the mobile device is in a first mode.

7. The mobile communication device of claim 6, wherein the first mode is an idle mode.

8. The mobile communication device of claim 6, further comprising:
means for selecting a second screen displayed on the mobile device by interacting with the user interface of the mobile device;
means for setting one or more conditions under which the first and second screens are to be displayed; and
means for displaying the first and second screens on the display of the mobile device when the device is in the first mode, in accordance with the one or more conditions.

9. A computer readable medium for storing logic code executable by a microcontroller, the logic code comprising the steps of:
selecting a second screen displayed on the mobile device by interacting with the user interface of the mobile device, wherein a first screen defines the idle screen;
setting one or more conditions under which the first and second screens are to be displayed; and
displaying the first and second screens on the display of the mobile device when the device is a first and a second mode, respectively, in accordance with the one or more conditions.

10. The computer readable medium of claim 9, wherein the first mode is a first idle mode and the second mode is a second idle mode.
